(19) United States
(12) Patent Application Publication
(10) Pub. No.: US 2015/0347547 A1
(43) Pub. Date: Dec. 3, 2015

(54) Replication in a NoSQL System Using Fractal Tree Indexes

(71) Applicants: Zardosht Kasheff, New York, NY (US); Leif Walsh, Brooklyn, NY (US); John Esmet, Brooklyn, NY (US); Richard Prohaska, Westford, MA (US)

(72) Inventors: Zardosht Kasheff, New York, NY (US); Leif Walsh, Brooklyn, NY (US); John Esmet, Brooklyn, NY (US); Richard Prohaska, Westford, MA (US)

(21) Appl. No.: 14/292,588

(22) Filed: May 30, 2014

(51) Int. Cl. G06F 17/30

(52) U.S. Cl. CPC G06F 17/30575; G06F 17/30371

(57) ABSTRACT

A method and system for replication in a noSQL database using a global transaction identifier (GTID) unique to each transaction and stored with an associated operations log. The GTID specifies the applicable primary, the sequence of the transaction, and, optionally, also includes information on whether the transaction was applied to a given primary, and for secondaries whether the transaction was applied to the collections. This method and system provides recovery for a crashed primary, re-integrating the crashed primary as a secondary, and point-in-time recovery, optionally having user-specified parameters from which recovery commences.

### PRIOR APPLICATIONS

This application claims priority to provisional application Ser. No. 61/828,979, filed 30 May 2013, the disclosure of which is incorporated herein by reference in its entirety.

### BACKGROUND OF THE INVENTION

1. Field of the Invention

The present invention involves a database system that uses a noSQL database in combination with fractal tree Indexes to achieve improved replication replication, including improved replication performance.

2. The Art

The present invention involves a noSQL database. A database may be a relational database accessed by SQL (sequential query language, such as the open-source relational database MySQL). An alternative, such as the noSQL commercially-available MongoDB (trademark of MongoDB, Inc., New York, N.Y.) has JSON-like documents (JSON being the acronym for JavaScript Object Notation, an open standard that uses human-readable text to transmit data objects), and uses B-tree indices.

A. Comparative Glossary of Exemplary noSQL Versus SQL.

A brief glossary of how some terms relate between MongoDB and MySQL is:

| MongoDB | MySQL |
|---|---|
| collection | table |
| primary | master |
| secondary | slave |
| opLog | binary log for master |

At a high level, standard MongoDB (noSQL) replication works as follows. Replication setups, called replica sets, have one primary instance and one or more secondary instances. All writes are made to the primary instance (or “primary”), and replicated asynchronously to the secondary instances (“secondaries”). The secondaries are read-only. To modify a secondary, one must take the secondary out of the replica set. If the primary goes down for some reasons, one of the secondaries gets promoted to be the new primary. In other words, such a system has “automatic failover.” The result is that whatever data that was on the primary that did not make it to the secondaries is lost.

B. Replication Algorithms

i. Simple Replication

The data in a noSQL versus an SQL database is sometimes handled differently. MongoDB versus MySQL are used as comparative examples.

On the primary in MongoDB, the replication data is stored in a collection that is called the opLog. In contrast, in MySQL the master stores replication data in flat files called the binary log. In MongoDB, this information is stored in another dictionary. The present invention uses the noSQL structure, so that writing to the opLog can be done with the same transaction that does the actual work, simplifying the problem of keeping the opLog consistent with the state of collections. In comparison, with MySQL a two-phase commit is performed.

The replication is performed by MongoDB an MySQL in a similar fashion. In MySQL's row based replication, individual inserts, updates, and deletes are replicated. Thus, if an update statement updates 100 rows in MySQL, then 100 individual entries are placed in the opLog for a corresponding MongoDB system. For updates and deletes, both can avoid logging the entire row, and instead log just the id field and the differences between the old row and the new row, called the delta.

Because MongoDB statements are not transactional, statements write to the opLog as they modify collections of data. If a crash or error occurs, then nothing is rolled back: it is the state of the opLog that reflects the data in the collections.

The locking that protects access to the opLog is a database-level lock. In standard MongoDB, all collections are protected by a database-level lock.

When data is modified in a primary in MongoDB, for each row modification (be it insert, delete, or update), the collection is updated. The opLog is then updated to reflect that change. Whereas it might be assumed the data has then been fixed into the MongoDB, the modification is not yet durable and may disappear on a crash. The system does not roll back any changes after this point; that is, while in earlier stages the system may try to undo some work done (e.g., finding a uniqueness violation may cause data from other indexes to be undone), but for a MongoDB system, this is a point of no return.

As data is inserted, threads are made aware that there is now new data to be sent to secondaries using a mechanism called a “long-polling tailable cursor”. Secondaries in MongoDB do not have the equivalent of a relay log. (In MySQL, the relay log stores data read from the binary log that is to be applied to a secondary/slave. The binary log, on the other hand, stores data that has been applied to tables/collections on a machine.) As data comes in, it is placed in an in-memory queue. While data is stored in the queue, secondaries use multiple threads to apply the in-memory queue data to the collections in parallel and to the opLog. The parallelism occurs on a per-collection or per database basis. Modifications can occur in this fashion because there are no multi-statement transactions that touch multiple collections. As data is applied, notifications are sent to the primary to say the data has been stored. A user can run getLastError( ) with certain parameters specified to cause the log to be fsync'd.

There are some distinct properties in the MongoDB implementation of a noSQL database. For example, MongoDB's opLog is idempotent (meaning that certain applications, functions, call, or other operations can be applied multiple times without changing the result beyond the change effected by the initial application). MongoDB uses idempotency to cope with being non-transactional. Another property is that, when coming up from a crash, idempotency can be used fill gaps in the opLog: if there are gaps in the opLog, a safe point known to have no gaps before it can be found, and replication can be started from that point. This may result in some data being replicated twice, but that not a problem because of the idempotency. Still further, because MongoDB is not transactional, a large update statement is not problematic as it would be in MySQL row based replication (where, if many updates are done (e.g., 10 million), those modifications need to either be applied together or not at all). Whereas this case will require much data to be written to the opLog, it can be written as the work is performed, so there is not a large stall at the end of the transaction to replicate all of the data the way there is with MySQL.

ii. Creating a Secondary.

At a high level, here is how a secondary is created in MongoDB:

the position in the opLog is recorded;

data is copied iterating over the opLog and all collections;

when that copying to the secondary is complete, replication is started from the primary starting at the aforementioned recorded position.

Because MongoDB is not transactional, the state of the copied collections is not a snapshot from the time the position in the opLog was recorded. The state of each collection is undefined. However, assuming the opLog is, in fact, idempotent, then one can start at the recorded position, catch up with the primary, and be assured that the secondary is in sync with the primary. Thus, the MongoDB replication algorithm depends on the idempotency of applying opLog data to secondaries.

iii. Failover (Recovering from a Crash) in MongoDB.

When a secondary fails, it is brought back up and is caught up with the primary. Because the secondary is guaranteed to be behind the primary, this seems straightforward. However, if the primary goes down, a secondary must step up and become primary.

For the purposes of this section, consider two kinds of secondaries: (a) those that can become a primary in the event of a failover (as defined by the user); and (b) those that cannot become a primary. When the primary goes down, all secondaries have data up to some position in the opLog. Note that this does not mean that all data has been applied, just that the data resides in the opLog. In MongoDB, the secondary that is the furthest along is chosen to become the primary (type (a)). (If there is a tie, based on user settings, the tie is broken by predefined protocol.) However, If this secondary is ineligible to become the new primary (that is, type (a) becomes type (b)), then some eligible secondary connects to this secondary, is brought up to date by this secondary via replication, and that eligible secondary becomes the new primary. This new primary then finishes by applying all the data in its opLog to its collections, after which normal operation can resume. Note that the secondary that became the new primary may be lacking some data that the old/crashed primary did have.

What happens to the old secondary that was ineligible to become a primary? As noted, the eligible secondary may be lacking data that was in the crashed primary. Because some of its data may not be on the new primary, it cannot just be designated as a secondary. To handle such a rollback situation to recover from a crash, MongoDB picks a secondary and compares it with the crashed primary to find the common point at which its opLog and the secondary's opLog diverge (using opLog entry hashes, h). Call this point t₀. Now the primary needs to roll back all of the operations its opLog later than (subsequent to) time t₀ (the time of the crash, or discovery of the crash). MongoDB iterates through those opLog entries to identify the complete set of documents (that is, subsequent to time t₀) that would be affected by the rollback. Thus, at time t₁, later than t₀, and effectively when the recovery is started, MongoDB queries the secondary for this complete set of documents in their present state and saves them in their appropriate collections. It then applies B's oplog entries as normal from t₀ to t₁. At the end of this operation, MongoDB considers the data to be a consistent (that is, recovered). Note, again, that this design relies on idempotency, and does not assure that the complete data set has been recovered.

### SUMMARY OF THE INVENTION

In light of the foregoing, one object of this invention is to run replication on the primary with an opLog that reflects the state of collections before sending the opLog over to the secondary.

Another object of this invention is to create a secondary from a primary and have the secondary up and running.

Yet another object of this invention is to handle crashes, both on the primary and on the secondary, with automatic failover to the secondary.

Yet another object of this invention is having the secondary run in parallel in certain desired contexts, such as when the fractal tree is not fast enough, and having the secondary run sequentially when it is fast enough.

Yet another object of this invention is to provide a replication system that runs in parallel, with little mutex contention.

Still a further object of this invention is to have a replication system that runs transactionally; for example, when providing transactional semantics the replication system honors transactions.

In one embodiment, this invention provides a database system comprising a primary and one or more secondaries, each primary and each secondary having an opLog file and associated dictionary, a global transaction ID (“GTID”) manager that assigns, in ascending order, to a transaction that operates on said primary that is ready to commit, a GTID that uniquely identifies that particular transaction on all machines in the replica set, each GTID comprising two integers, one of said integers identifying the primary and the other of said integers identifying the transaction in a sequence of transactions, and the opLog file having a dictionary keyed by the GTID.

In all embodiments of this invention, the indexes preferably comprise write-optimized indexes, particularly fractal tree indexes.

In another embodiment, this invention provides a method for replicating data in a data storage system, such as a noSQL system, comprising, providing a database comprising a primary and a secondary, each primary and each secondary having an associated opLog and opLog dictionary, said primary and secondary indexed by fractal trees, for each transaction operating on said primary and ready to commit, assigning to said transaction, in sequential ascending order, a unique identifier comprising information identifying the primary and the particular transaction, indexing said opLogs by said unique identifier, tracking whether said transaction did commit, and replicating said primary in ascending order of said unique identifiers stored in said associated opLog to a secondary only so long the sequentially-next unique identifier has committed. This embodiment may also include creating a snapshot copy of said primary, periodically writing to a replication information dictionary the minimum unique identifier that has not yet committed, locking the fractal tree indices for said primary, making a copy of said replication information dictionary, the primary opLog associated with said primary, and all collections associated therewith, determining the minimum uncommitted unique identifier in the copied opLog, where, prior to making said copy, said unique identifiers were applied to the opLog prior to being applied to said collections, and starting replication therefrom to create a secondary.

In another embodiment, the unique identifier further comprises applied state information, said applied state information set to “true” when transaction information is added to the opLog for said primary, said applied state information set to “false” when transaction information is added to the opLog for said secondary and set to “true” when such information is applied to collections associated with said secondary. Such embodiments may also include periodically writing to a replication information library the minimum unique identifier that has not been committed.

In yet another embodiment, the invention further comprises reading from said replication information library the minimum unique identifier that is not applied, reading forward in the opLog associated with said secondary from the point of said minimum unique identifier, determining the applied state information of said unique identifier, and applying the transaction information in said unique identifier only when the applied state information is “false” to create a new primary. The unique identifier may further comprise both information identifying the primary to which such transaction is applied and the sequence in which such transaction is applied to such primary.

In yet another embodiment, the method further comprises examining the opLog of the new primary created by the method mentioned above with the opLog of a crashed primary to identify the unique identifier identifying the same primary and having the greatest transaction sequence that is common to both opLogs, rolling back the crashed primary according to its associated opLog until such common identifier is reached to create a new secondary, and integrating such new secondary into the database.

In still another embodiment, the invention includes user-prompted point-in-time recovery by reading forward in the opLog associated with said secondary from a point specified by a user of the system, determining the applied state information of said unique identifier, and applying the transaction information in said unique identifier only when the applied state information is “false” to create a new primary. The invention may operate by deleting the opLog to the specified point, or adding opLog entries which are the inverse of operations from said specified point.

### DETAILED DESCRIPTION

The present database invention uses write-optimized indices, such as fractal tree indices (as described, for example in U.S. Pat. No. 8,185,551 and published U.S. Published Patent Application No. 20110246503, the disclosures of which are incorporated herein by reference in their entirety). Fractal tree indexes are organized as search trees containing message buffers. Messages are inserted into the root node of a search tree. Whenever a node of a search tree is evicted, the messages in that node are saved along with the rest of the node. Whenever a node is full (depending on how space is allotted), messages are sent to the child nodes. When messages arrive at a child node they are applied to the search tree. The fractal tree system supports multiversion concurrency control and transactions.

For ease of discussion, the detailed description may be described in terms of a single primary and a single secondary, it being understood that the invention is applicable to multiple primaries and their associated one or more secondaries.

### Replication of a Primary

A. Committed Data

In this invention, individual statements are atomic rather than individual updates, and the opLog reflects this atomicity. If, for example, a statement performs 100 updates successfully, then all 100 are present in the opLog; if the statement fails, then none of them end up in the opLog. This can be implemented as follows.

As a transaction does work, all operations involved in that transaction are logged in a buffer local to the transaction. If a predetermined buffer size is exceeded, then the buffer contents will spill into another dictionary, termed herein the localOpRef (for local Operations Reference) dictionary, to avoid oversubscribing memory or if there is insufficient memory.

When the transaction is ready to commit, the transaction gets a global transaction ID (GTID) from a GTID Manager. GTIDs are handed out in increasing order. Each GTID will identify a particular transaction on all machines in the replica set, now and in the future. The key in the opLog dictionary is prefixed by the GTID.

Then the transaction, associated to the assigned GTID, proceeds to write to the opLog all operations performed according to that transaction. The writing is performed with attention to buffer. If the transaction's buffer did not spill over, then the opLog information is written directly to the opLog. If the transaction's buffer spilled into the localOpRef dictionary, then the remaining opLog information is written to the localOpRef dictionary, and a reference to the localOpRef is stored in the opLog. Thus, the system can sometimes avoid copying all the data from the LocalOpRef into the opLog.

All operations for a transaction are logically contiguous in the opLog.

Once the transaction commits, the data in the opLog and in the database system are committed.

After commit, the transaction notifies the GTID manager that this GTID has committed.

B. Replication to a Secondary

Only committed data is replicated. All data is replicated to secondaries in increasing GTID order. (That is, the system does not “go backwards” in the opLog to replicate data.) For example, with separate GTIDs labeled “A,” “B,” and “C,” with A<B<C, if A and C have committed, but B has not yet committed, then only A is replicated. In this example, C is not replicated because B has yet-to-commit and so is not replicated until it is committed. In this example, once B has committed and replicated, then C may be replicated.

Such a replication protocol can be accomplished by the aforementioned GTID manager maintaining the minimum GTID that has yet to commit. Secondaries can replicate up to but not including the minimum GTID that has yet to commit. Whenever the minimum GTID yet to commit changes, appropriate secondaries are signaled to replicate more data. One implication of this choice is that, if the minimum GTID happens to be assigned a large transaction, the time to commit may be long, and so replication lag may occur.

One benefit of such a process is that transactions can write to the opLog in parallel: the only serialized piece is the GTID generation. However, one disadvantage is that large transactions may perform badly by causing replication lag: a large transaction that does a lot of work takes a long time, causing a lot of data to be transferred after commit. Because replication is row-based, large transactions cause lots of bandwidth and disk usage. An alternative method according to this invention would be to shift the work done onto background threads to reduce latency. Another alternative according to this invention would be to reorganize the log to eliminate the requirement that transactions commit in increasing order, while preserving information about which transactions can be run in parallel in the opLog. In contrast, some of the existing art (such as standard MongoDB) does not have the lag issue for large transactions only because those systems do not support large transactions; those systems write to and replicate data as it is written to the opLog, not waiting for any transaction or statement to complete. Other art (such as MySQL) has a similar lag issue. On a primary according to the present system, a large transaction will not stall other transactions by blocking access to the opLog, in contrast to some relational DBs (such as MySQL) where a large transaction blocks access to the binary log.

### 2. Secondaries

A. Creating Secondaries

Because applying the opLog according to this invention may not be idempotent, the present invention does not rely on the same algorithm that, for example, MongoDB uses. For the system of this invention, consider the situation in which a snapshot is taken of the primary file system using a backup utility. (This snapshot might be taken by using the logical volume manager (LVM) to take a snapshot of the block device on which the file system resides, or the snapshot could be taken by the file system. The point is that the backup so made is a copy of the data as it appeared on disk at a particular moment in time.) According to the present invention, a snapshot is used to make a backup copy that is instantiated on another machine, and then recovery is run on the fractal tree system. The resulting data is then used to create a new secondary.

Using such operations, it is important to bring this newly created secondary up-to-date with respect to the primary. Suppose, for example, that the primary opLog has GTIDs A, B, and C (where A<B<C). Suppose also that this newly created secondary has A and C committed, but not B. When the backup was made, its opLog contained A and C, but had no record of B. For this backup to be a valid secondary, it is important that replication of the primary start at a point that ensures B is included. As mentioned previously, the primary cannot start replicating at C because then B is missed (not yet having been committed). Analogous to the example explained above, replication should start from a point where it is known the backup has all GTIDs prior to that point applied. The point at which replication starts does not need to correspond to the largest such GTID, as the backup can filter out and not apply GTIDs that have already been applied (e.g., A or C in this case).

Here is how we select that point for replication. On a background thread on the primary, once every short period of time (say, once per second), the primary writes the minimum uncommitted GTID to a dictionary, called the replInfo (replication Information) dictionary. The replInfo dictionary appears in the backup. The backup then uses this dictionary to determine the point at which replication should start. This point in time may be earlier than absolutely necessary, but if the period is short, it will be only a short time behind.

Even if taking a hot backup of a secondary instead of a primary, the same algorithm applies, as the secondary will also have a minimum uncommitted GTID. Note that this is the minimum uncommitted GTID applied to the opLog, as opposed to being applied to collections, since on secondaries data is replicated and committed to the opLog first, then later is applied to collections. With this data, making a hot backup into a secondary is done as follows. Take the hot backup, plug it in as a secondary, and start replication from this recorded point.

In another embodiment, suppose a hot backup system is not being used. In this situation, an alternative algorithm is used to create a new secondary instance. First, a snapshot transaction is made on the primary. Then grab lock tree locks on metadata dictionaries to ensure collections cannot be modified, because adding/dropping collections/indexes may cause issues where file operations do not offer MVCC (multiversion concurrency control). Next, the opLog, replInfo dictionary, and all collections are copied over to the secondary. Finally, the replInfo dictionary is used to determine where to start replication, as this snapshot will have the same issues that the hot backup has.

B. Running Secondaries

For this section, presume that secondaries can do work in parallel. The goal is a protocol for receiving data from the primary ensuring crash safety. Note that failover is not an issue here yet: failover is the act of recovering from a primary going down.

The secondary works as follows. One thread gets a GTID and data from the primary and transactionally writes it to the opLog. When the transaction commits, the data is, as far as the primary instance is concerned, now considered to be stored on the secondary instance. Another thread notices added GTIDs and spawns threads to apply them to collections. Assuming some GTIDs may be applied to collections in parallel implies that GTIDs may be committed to collections out of order.

Because clients can do only read queries on secondaries, there are several optimizations the present system can perform on slaves for writes. For instance, the lock tree can be bypassed. In addition, uniqueness checks can be skipped because the primary will have already verified uniqueness. Still further, no opLog operation requires a query-like update as do some relational database replication schemes (such as MySQL) because the opLog contains all necessary data to apply the operation without a query. As a result, applying writes on secondaries can be be very fast.

C. Secondary Crash Recovery

Because GTIDs are added to the secondary's opLog in order, the secondary knows the end of the opLog is the position where the primary must start replicating. Hence, the minimum uncommitted GTID is known; in particular, it is at the end of the opLog. In addition, with the present system there are no gaps in the opLog that must be filled by the primary.

Nevertheless, because the application of GTIDs to collections may happen out of order, there is not a defined location in the opLog where entries before that position have been applied to collections and entries after that position have not been applied. As with the previous examples, assume the secondary's opLog has GTIDs A, B, and C, where A<B<C, and where A and C have been applied but B has not. Upon recovering from a crash, the secondary must find a way to apply B, but not C. To accomplish this, the present system performs a number of operations. First, though, on all machines, for all primaries and associated secondaries, each GTID comprises a boolean byte, termed herein the “Applied State,” and is stored in the opLog as an indication whether that particular GTID has been applied to collections or not. On a primary, when data is added to the opLog, for a GTID the Applied State is set to “true” as part of the transaction doing the work. On a secondary, the transaction adding the replication data sets the Applied State byte of the GTID to “false” as part of that transaction. Then, when a secondary has a transaction apply the GTID to the collections, that transaction also changes the GTID's Applied State from “false” to “true.” On a background thread, once every short period of time (e.g., 1 second), the replInfo dictionary will be updated with the minimum unapplied GTID, that will be preferably be maintained in memory. Upon recovering from a crash, a conservative (that is, possibly earlier than necessary) value for the minimum unapplied GTID. Starting from that value, the opLog is read in the forward direction, and for each GTID, if its Applied State is “false” it is applied, and if it is “true” then it is not applied. Thereafter, the secondary is back up and running after a crash.

### 3. Failover/Primary Crash Recovery

If a primary crashes, a user will want one of two options: to have the primary go through crash recovery and come back as the primary; or an automatic failover protocol where an existing secondary becomes the new primary.

A. Recovering the Primary

In the case where there is no automatic failover (or that process is not desired for some reason), if the user wants to wait for the primary to undergo recovery and come back as the primary, then it must be assured that the recovered primary is still ahead of all secondaries (that is, there cannot be a secondary that contains data that the primary failed to recover, otherwise the date is inconsistent.)

To accomplish this, the conditions under which a GTID may be replicated are made stricter than in the case mentioned above, where a GTID may be replicated from the primary to a secondary by picking an opLog point assuring that all prior GTIDs have committed and have been replicated. In the case of recovering a primary, the system requires that the recovery log be fsynced to disk to ensure that, in the case of a primary crash, this GTID will be recovered. To ensure that all replicated GTIDs have been synced to disk and will survive a crash, the algorithm mentioned above in “replication of a primary” is altered so that all GTIDs up to the minimum uncommitted GTID before the last call to log_flush be committed. That is, if the logs are being flushed periodically, then before each flush the minimum uncommitted GTID is recorded, so that after the call to log_flush the recorded value is the new eligible maximum for replicated GTIDs.

B. Picking a New Primary in Case of Failover

In the case of automatic failover, there are two types of secondary indexes: a running secondary (that is, this machine was successfully running as a secondary and there are no gaps of missing GTID's in its opLog); and a synchronizing secondary (that is, his machine was in the process of synching with the primary, because it was newly created, and may have gaps of missing GTIDs in its opLog).

For simplicity of discussion, assume that, if a primary goes down, then any synchronizing secondary is unrecoverable and cannot be integrated into the replica set. Such machines are thus lost and must be rebuilt (or resynced) from scratch. Nevertheless, given a number of running secondaries, the secondary that has the largest committed GTID is selected to be processed into become the new primary: that secondary is the furthest ahead, so that secondary becomes the new primary. If there is a tie, then the tie is broken based on user settings. (If the secondary that is furthest ahead is deemed ineligible by the user (for whatever reason) to become the new primary, then some eligible secondary is connected to this ineligible secondary and is caught up to match the ineligible secondary). The eligible and caught up secondary then becomes designated to become the new primary. It will be apparent to one of ordinary skill in the art that, if a synchronizing secondary can be brought up to date, then it can be treated as a successful secondary.

Once a new primary has been selected, that primary must bring its collections fully up to date with its opLog; only then may the new primary may accept writes.

C. Re-Integrating the Old Primary as a Secondary

How a crashed primary can be re-integrated into the replica set as a secondary depends on the state of the data in the old primary after recovering from a crash. When a primary fails over to a secondary, some data that was committed on the primary may have never made it to the secondary that was promoted. If none of that data persists on the old primary after recovery, then the old primary can seamlessly step in as a secondary. However, if any of that data is on the old primary, then the primary must rollback that data before it can step in as a secondary, to put itself in sync with the new primary. If a spot in the old primary's opLog can be chosen as to point to rollback to, then, with point in time recovery, the opLog can be played backwards, deleting elements from the opLog while reversing the operations it has stored, until that chosen point in the opLog is reached, whereby the old primary can be integrated as a secondary.

It should be noted that a prior determination, whether rollback is even necessary, must be determined, and preferably that determination occurs prior to identifying the point in the opLog to which a rollback is performed. To make this prior determination, the GTID is further defined as containing two integers (preferably 8-byte integers) written, for example, as the pair “(primarySeqNumber, GTSeqN)”. The primarySeqNumber integer identifies the primary and changes only when the primary changes, which includes occurrences such as restarts of the primary and switching to another machine via failover. The GTSeqNumber integer indicates the transaction and increases with each transaction. Accordingly, for example, GTIDs of “(10,100), (10,101), (10,102), (11,0), (11,1), (11,2), . . . ,” and assuming that 10 and 11 are the only values for primarySeqNumber, indicate there was a failover or restart between (10,101) and (11,0). As first defined, the GTID is unique, so no GTID in the system will ever be assigned twice. It preferable also to store a hash in each opLog entry that is function of the previous operation and the contents of the current operation.

Thus, in repurposing a crashed (old) primary as a secondary, the GTIDs at the end of its opLog can be examined and scanned backwards until one is found that shows up in both the crashed/old primary and new primary. Once the greatest common GTID (between the old primary and the new primary) is identified, then so is the point in time to where the old primary must be rolled back to become a secondary, and after that rollback it can be re-integrated as a slave.

D. Parallel Secondaries, Applying the OpLog

Parallel slave replication is known in relational databases (such as MySQL 5.6). JSON-type databases (such as MongoDB) can also have threads running replication on parallel on secondaries. MariaDB (based on a fork of the MySQL relational database management system) has publically-available information on that systems, global transaction ID (GTID), parallel slave, and multisource replication at https://lists.launchpad.net/maria-developers/msg04837.html and https://mariadb.atlassian.net/browse/MDEV-26.

### 4. Point-in-Time Recovery

In another embodiment, this invention provides the feature of point-in-time recovery (a feature not present, for example, in standard MongoDB). With point-in-time recovery, a user can specify a location in the opLog to revert to. The actual process of reverting can either delete opLog entries while going backwards, or can add entries to the opLog that are the inverse of previous operations, and does not require a backup. (This feature also does not exist in MySQL without the existence of a backup, since MySQL can roll logs only forward, not backward. In MySQL, one can take a backup and recover only to a point in time going forward from the backup.)

This requires that all operations stored in the opLog be both (i) able to be applied and (ii) able to be reversed. (If the operation is not reversible (e.g., if one were to log a delete with just its primary key and not the full row), then point in time recovery will not work.) In addition, it is required that no deleting of files is permitted to appear in the opLog, because there is no ability to reverse the deletion of a file; to accommodate deletions, the deleted file is saved somewhere and referenced in the opLog.

To enhance performance, this invention using the following algorithms: when inserting into the opLog on primary, we don't need the lock tree, we can use DB_PRELOCKED_WRITE. In addition, if opLog overhead is high, we can make insertion speed can be increased by automatically pinning the leaf node of the fractal tree instead of descending down the tree.

The foregoing description is meant to be illustrative and not limiting. Various changes, modifications, and additions may become apparent to the skilled artisan upon a perusal of this specification, and such are meant to be within the scope and spirit of the invention as defined by the claims.

What is claimed is:

1. A database system, comprising:
a primary and one or more secondaries;
each primary and each secondary having an opLog file and associated dictionary;
a global transaction ID (“GTID”) manager that assigns, in ascending order, to a transaction that operates on said primary that is ready to commit, a GTID that uniquely identifies that particular transaction on all machines in the replica set, each GTID comprising two integers, one of said integers identifying the primary and the other of said integers identifying the transaction in a sequence of transactions; and
the opLog file having a dictionary keyed by the GTID.

2. The system of claim 1, comprising write-optimized fractal tree indices.

3. The system of claim 2, wherein the indices are fractal tree indices.

4. The system of claim 1, wherein the primary data is replicated to one or more secondaries in increasing GTID order based first on said integer identifying the primary and next on said integer identifying the transaction.

5. The system of claim 1, wherein the GTID further comprises information indicating the applied state.

6. A method for replicating data in a data storage system, comprising:
providing a database comprising a primary and a secondary, each primary and each secondary having an associated opLog and opLog dictionary, said primary and secondary indexed by fractal trees;
for each transaction operating on said primary and ready to commit, assigning to said transaction, in sequential ascending order, a unique identifier comprising information identifying the primary and the particular transaction;
indexing said opLogs by said unique identifier;
tracking whether said transaction did commit; and
replicating said primary in ascending order of said unique identifiers stored in said associated opLog to a secondary only so long as the sequentially-next unique identifier has committed.

7. The method of claim 6, further comprising:
creating a snapshot copy of said primary;
periodically writing to a replication information dictionary the minimum unique identifier that has not yet committed;
locking the fractal tree indices for said primary;
making a copy said replication information dictionary, the primary opLog associated with said primary, and all collections associated therewith;
determining the minimum uncommitted unique identifier in the copied opLog, where, prior to making said copy, said unique identifiers were applied to the opLog prior to being applied to said collections, and starting replication therefrom to create a secondary.

8. The method of claim 6, wherein said unique identifier further comprises applied state information, said applied state information set to “true” when transaction information is added to the opLog for said primary, said applied state information set to “false” when transaction information is added to the opLog for said secondary and set to “true” when such information is applied to collections associated with said secondary.

9. The method of claim 8, further comprising periodically writing to a replication information library the minimum unique identifier that has not been committed.

10. The method of claim 9, further comprising reading from said replication information library the minimum unique identifier that is not applied, reading forward in the opLog associated with said secondary from the point of said minimum unique identifier, determining the applied state information of said unique identifier, and applying the transaction information in said unique identifier only when the applied state information is “false” to create a new primary.

11. The method of claim 10, wherein said unique identifier further comprises both information identifying the primary to which such transaction is applied and the sequence in which such transaction is applied to such primary.

12. The method of claim 11, further comprising:
examining the opLog of said new primary created by the method of claim 10 with the opLog of a crashed primary to identify the unique identifier identifying the same primary and having the greatest transaction sequence that is common to both opLogs;
rolling back the crashed primary according to its associated opLog until such common identifier is reached to create a new secondary; and
integrating such new secondary into the database.

13. The method of claim 9, further comprising reading forward in the opLog associated with said secondary from a point specified by a user of the system, determining the applied state information of said unique identifier, and applying the transaction information in said unique identifier only when the applied state information is “false” to create a new primary.

14. The method of claim 13, wherein opLog entries are deleted to said specified point.

15. The method of claim 13, wherein opLog entries are added, said entries being the inverse of operations from said specified point.
